(19) United States
(12) Patent Application Publication
(10) Pub. No.: US 2011/0211719 A1
(43) Pub. Date: Sep. 1, 2011

(54) DISPLAY DEVICE

(75) Inventor: Tsuyoshi Okumura, Osaka (JP)

(73) Assignee: SANYO ELECTRIC CO., LTD., Osaka (JP)

(21) Appl. No.: 13/035,386

(22) Filed: Feb. 25, 2011

(30) Foreign Application Priority Data
Feb. 26, 2010 (JP) 2010-041840

(51) Int. Cl. H04R 1/02

(52) U.S. Cl. 381/333

(57) ABSTRACT

In a display device according to the present invention, an image display panel is mounted in a casing including a front cabinet and a back cabinet, and a speaker is mounted in a bottom portion of the back cabinet. A support piece is provided projecting on an inner surface of the front cabinet, a rib is provided projecting on an inner surface of the back cabinet, and the speaker is sandwiched between the support piece and the rib. The support piece can independently temporarily fix the speaker on the support piece without sandwiching the speaker between the support piece and the rib.

Japanese Patent Application No. 2010-41840 on which the priority claim of this patent application is based is incorporated herein by reference.

### BACKGROUND OF THE INVENTION

1. Field of the Invention

The present invention relates to a display device where an image display panel is accommodated in a casing.

2. Description of the Related Art

In conventional television receivers as a display device, a front cabinet and a back cabinet are joined together to constitute a casing, and a speaker is mounted in a bottom portion of the front cabinet with its sound emission direction facing downward. It has been proposed to hold the speaker by engaging the back cabinet with the front cabinet and thereby sandwiching the speaker between the both cabinets.

In an assembling process of a television receiver including an image display panel such as a liquid crystal display panel, two lead wires leading from a speaker are fixed along the surface of a metal plate arranged on the back surface of the image display panel, and distal end portions thereof are connected to a circuit board on the back cabinet side in a state in which the image display panel and the speaker are mounted on the front cabinet.

EMC measures are taken by fixing the two lead wires leading from the speaker along the surface of the metal plate arranged on the back surface of the image display panel as described above. However, when the design of the front cabinet is to be improved by integrally molding the front cabinet from colored synthetic resin, for example, the front cabinet is preferably designed as simple as possible. It is thus necessary to arrange the speaker in the back cabinet.

In the structure where the speaker is arranged in the back cabinet, the two lead wires leading from the speaker arranged in the back cabinet need to be fixed along the surface of the metal plate of the image display panel mounted on the front cabinet in the assembling process of the television receiver. The operation needs to be performed between the two cabinets, and is thus troublesome.

### SUMMARY OF THE INVENTION

In a display device according to the present invention, an image display panel 5 is mounted in a casing 1 including a front cabinet 2 and a back cabinet 3 such that a screen can be viewed from a front surface side of the front cabinet 2, and a speaker 4 is mounted in a bottom portion of the back cabinet 3 with a sound emission direction facing downward.

A support piece 21 is provided projecting toward the speaker 4 on an inner surface of the front cabinet 2, a rib 32 is provided projecting toward the speaker 4 on an inner surface of the back cabinet 3, and the speaker 4 is sandwiched between the support piece 21 and the rib 32 in a state in which the front cabinet 2 and the back cabinet 3 are joined together.

The support piece 21 has a support structure capable of independently temporarily fixing the speaker on the support piece 21 without sandwiching the speaker 4 between the support piece 21 and the rib 32, and fixes the speaker 4 more rigidly than when the speaker 4 is temporarily fixed by sandwiching the speaker 4 between the support piece 21 and the rib 32.

### BRIEF DESCRIPTION OF THE DRAWINGS

FIG. 1 is a perspective view of a television receiver as a display device according to one embodiment of the present invention;

FIG. 2 is a sectional view illustrating a sandwiched state of a speaker;

FIG. 3 is a sectional view illustrating the same at a different position from that in FIG. 2 (a center position of the speaker);

FIG. 4 is a sectional view illustrating the same at a different position from that in FIG. 3;

FIG. 5 is an exploded perspective view of the television receiver as a display device;

FIG. 6 is a perspective view illustrating the back surface of an image display panel mounted on a front cabinet;

FIG. 7 is a perspective view illustrating a state in which the speaker is temporarily fixed on a support piece of the front cabinet;

FIG. 8 is a perspective view illustrating the support piece of the front cabinet;

FIG. 9 is an exploded perspective view illustrating the support piece of the front cabinet and a rib of a back cabinet; and

FIG. 10 is an assembled perspective view illustrating the same.

### DETAILED DESCRIPTION OF THE PREFERRED EMBODIMENTS

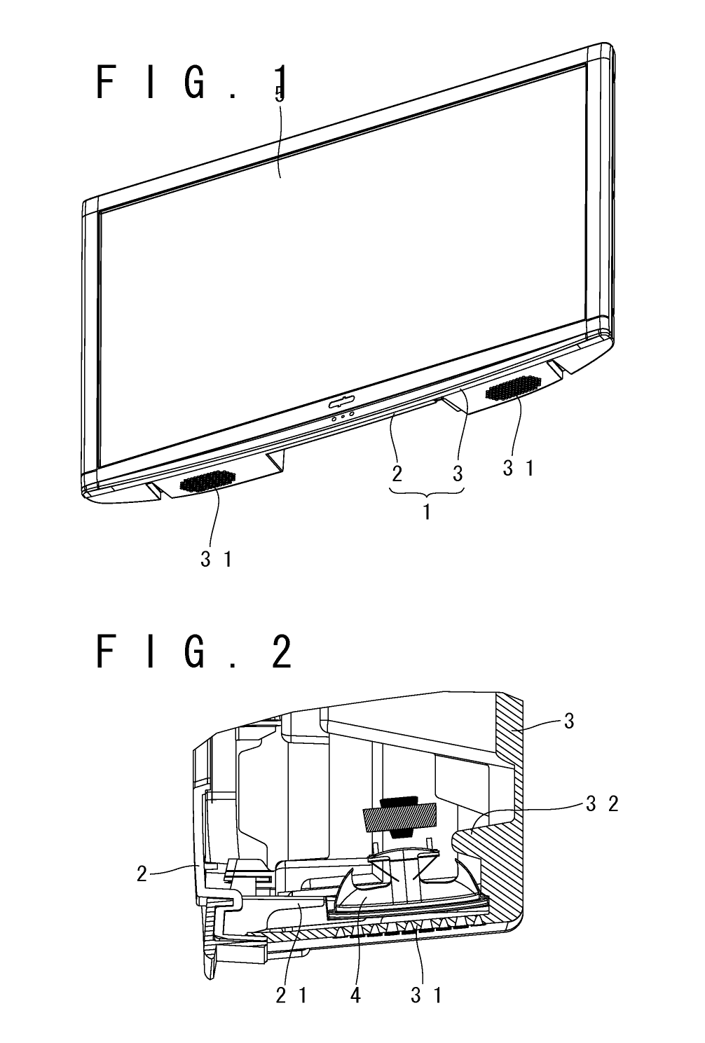

In the following, an embodiment of the present invention will be described in detail based on the drawings. In a display device according to the present invention, an image display panel 5 is accommodated in a casing 1 obtained by joining a front cabinet 2 and a back cabinet 3, and a screen of the image display panel 5 is exposed from the front surface of the front cabinet 2 as shown in FIG. 1. Sound emission holes 31 and 31 for emitting acoustic sound of right and left two channels are also formed in the bottom surface of the back cabinet 3.

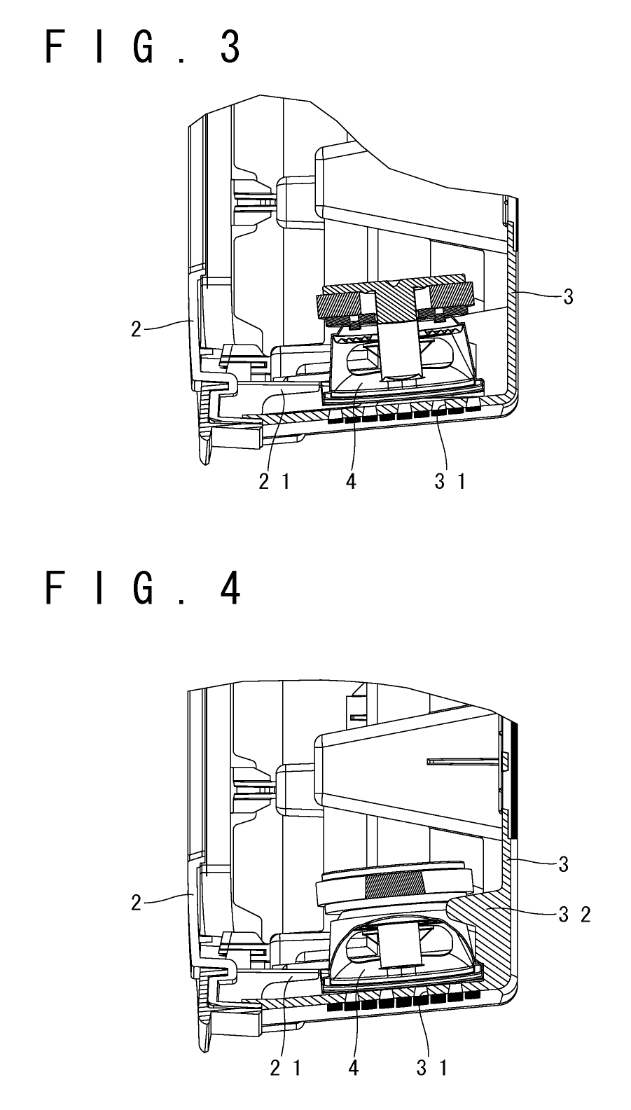

As shown in FIGS. 2 to 4, a pair of right and left speakers 4 and 4 are mounted in a bottom portion of the back cabinet 3 with their sound emission direction facing downward.

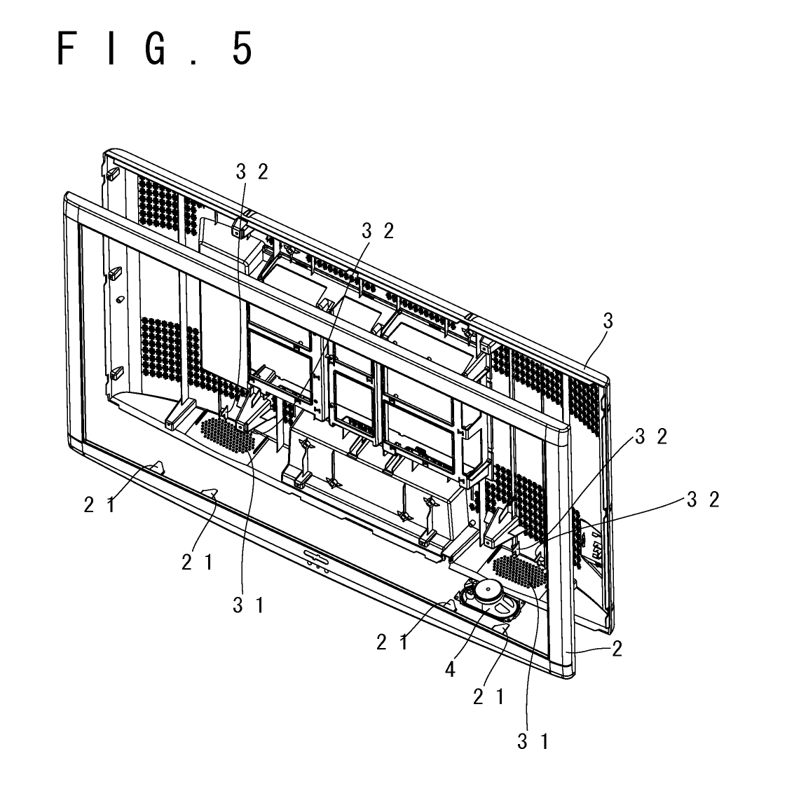

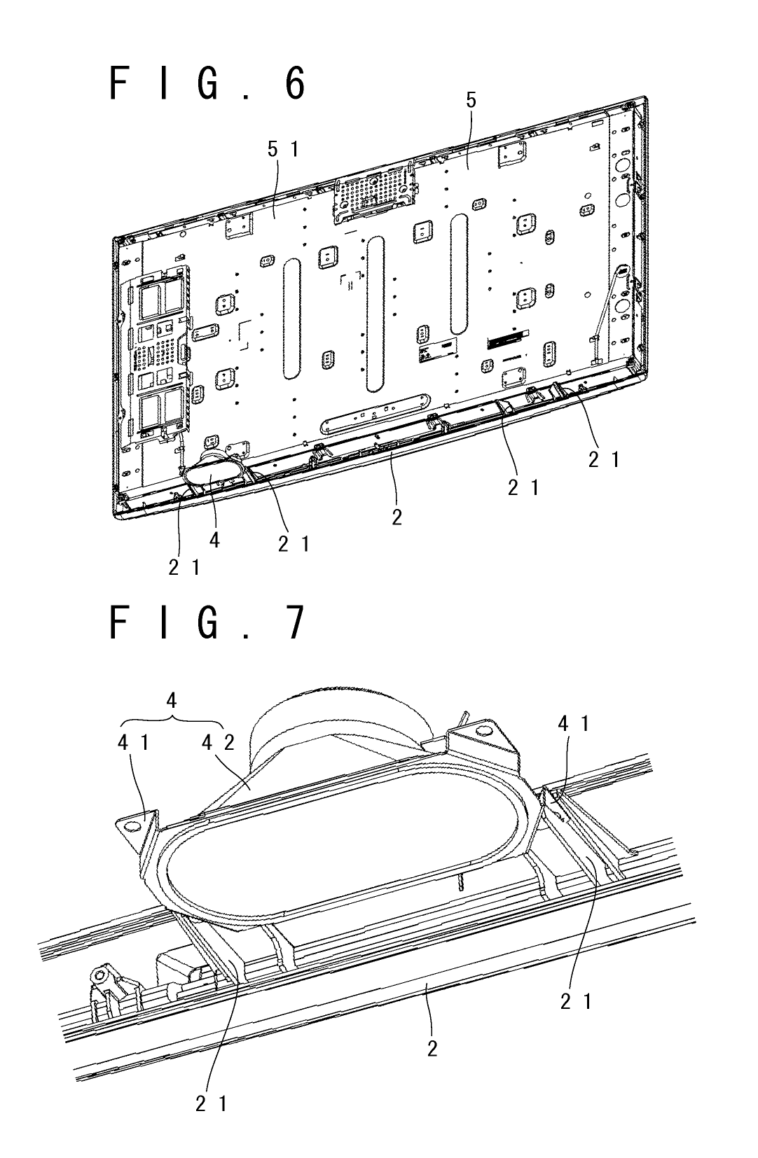

As shown in FIG. 5, two support pieces 21 and 21 are provided projecting toward each of the speakers 4 on the inner surface of the front cabinet 2, and two ribs are also provided projecting toward each of the speakers 4 on the inner surface of the back cabinet 3.

As shown in FIGS. 2 to 4, the speaker 4 is sandwiched between the support piece 21 of the front cabinet 2 and the rib 32 of the back cabinet 3 in a state in which the front cabinet 2 and the back cabinet 3 are joined together.

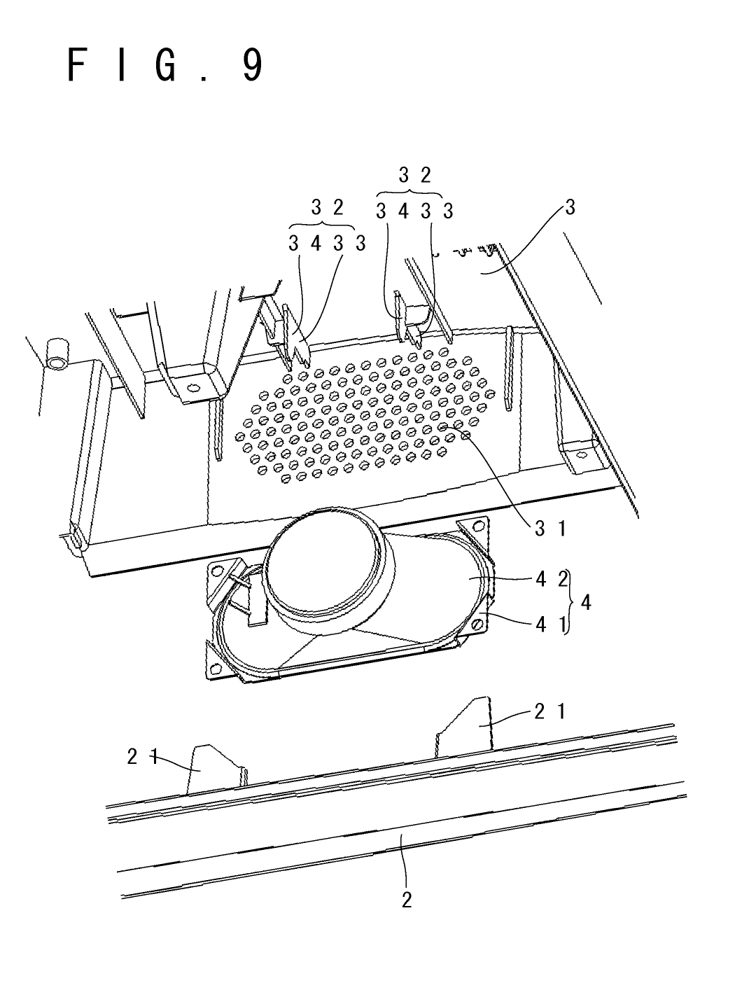

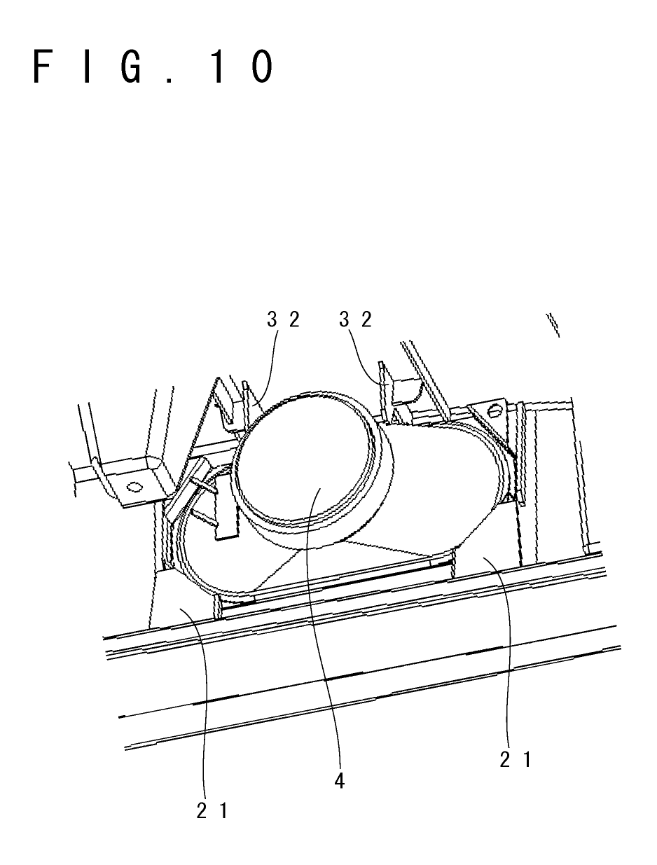

As shown in FIG. 8, the support piece 21 includes a first projection portion 22 and a second projection portion 23 projecting from the inner surface of the front cabinet 2 toward the back cabinet 3. A frame 41 of the speaker 4 shown in FIG. 9 can be sandwiched between the first projection portion 22 and the second projection portion 23.

Meanwhile, the rib 32 of the back cabinet 3 includes a first projection portion 33 projecting from the bottom surface of the back cabinet 3 and a second projection portion 34 bent from the upper end of the first projection portion 33 toward the front cabinet 2 as shown in FIG. 9. The rib 32 is thereby formed in an L shape.

By joining the front cabinet 2 and the back cabinet 3 together, the speaker 4 is sandwiched between the support piece 21 of the front cabinet 2 and the rib 32 of the back cabinet 3 as shown in FIG. 10.

In this state, the rib 32 of the back cabinet 3 shown in FIG. 9 has the first projection portion 33 abutting against the frame 41 of the speaker 4, and the second projection portion 34 abutting against the back surface of a speaker body 42 to thereby fasten the speaker 4.

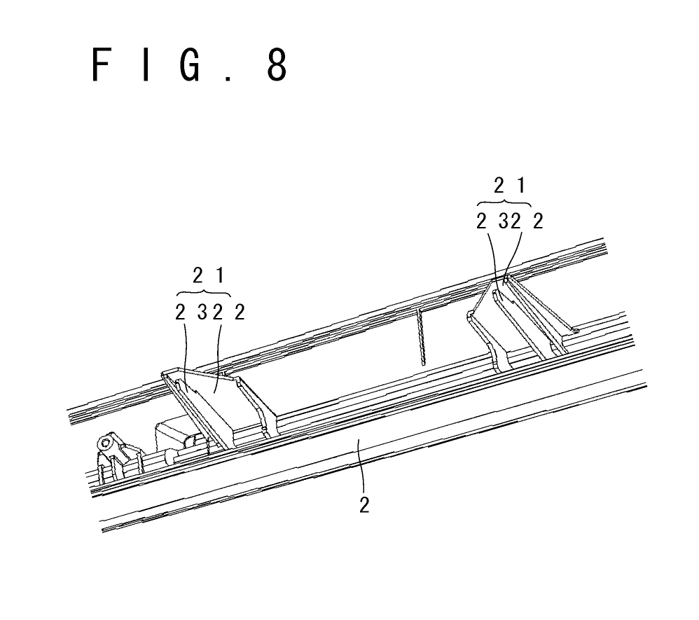

In an assembling process of the aforementioned television receiver, the speaker 4 is first temporarily fixed on the support piece 21 of the front cabinet 2 in a state in which the image display panel 5 is mounted on the front cabinet 2 as shown in FIGS. 6 and 7.

The front cabinet 2 is mounted on a work platform with the front surface of the front cabinet 2 (the screen of the image display panel 5) facing downward. The support piece 21 of the front cabinet 2 thereby stands projecting vertically upward, so that the speaker is supported on the support piece 21 in a self-standing state. The speaker 4 is temporarily fixed on the support piece 21 of the front cabinet 2 in such a manner.

Two lead wires (not shown) leading from the speaker 4 are fixed along a metal plate 51 provided on the back surface of the image display panel 5 in this state. EMC measures are thereby taken.

After that, the back cabinet 3 is engaged with the front cabinet 2, to sandwich the speaker 4 between the support piece 21 of the front cabinet 2 and the rib 32 of the back cabinet 3 as shown in FIGS. 2 to 4.

The speaker 4 is thereby mounted in the bottom portion of the back cabinet 3 with the sound emission direction facing downward, and is thereby more rigidly fixed to the casing 1 than in the temporarily-fixed state described above.

In this state, distal end portions of the two lead wires leading from the speaker 4 are connected to a circuit board (not shown) mounted on the back cabinet 3. This operation can be performed through an opening formed in the back cabinet 3.

As described above, the speaker 4 can be temporarily fixed on the support piece 21 of the front cabinet 2 in the assembling process. Thus, the operation of fixing the two lead wires leading from the speaker 4 along the metal plate 51 provided on the back surface of the image display panel 5 is facilitated as compared to the operation performed in a state in which the speaker 4 is mounted on the back cabinet 3 as in a conventional case.

In the aforementioned television receiver, the speaker 4 is fixed to the casing 1 by being sandwiched between the support piece 21 of the front cabinet 2 and the rib 32 of the back cabinet 3, and a fastening structure using a screw or the like is not employed. Thus, the number of components can be reduced and the assembling process can be simplified.

It should be noted that the configuration of each portion of the present invention is not limited to that in the aforementioned embodiment, and various modifications may be made therein by a person skilled in the art without departing from the spirit of the present invention as set forth in the claims. For example, the sandwiching structure using the support piece 21 of the front cabinet 2 and the rib 32 of the back cabinet 3 is not limited to the aforementioned configuration and various known sandwiching structures may be employed.

What is claimed is:

1. A display device, wherein an image display panel is mounted in a casing including a front cabinet and a back cabinet such that a screen can be viewed from a front surface side of the front cabinet, and a speaker is mounted in a bottom portion of the back cabinet with a sound emission direction facing downward,
a support piece is provided projecting toward the speaker on an inner surface of the front cabinet, a rib is provided projecting toward the speaker on an inner surface of the back cabinet, and the speaker is sandwiched between the support piece and the rib in a state in which the front cabinet and the back cabinet are joined together, and
the support piece has a support structure capable of independently temporarily fixing the speaker on the support piece without sandwiching the speaker between the support piece and the rib, and fixes the speaker more rigidly than when the speaker is temporarily fixed by sandwiching the speaker between the support piece and the rib.

2. The display device according to claim 1, wherein the support structure of the support piece of the front cabinet comprises a first projection portion and a second projection portion for sandwiching a frame of the speaker from both sides.

3. The display device according to claim 1, wherein the support structure of the support piece of the front cabinet allows the speaker to stand by itself on the support piece in a posture in which the front cabinet is mounted with the front surface facing downward.

4. The display device according to claim 3, wherein the support structure of the support piece of the front cabinet comprises a first projection portion and a second projection portion for sandwiching a frame of the speaker from both sides.
